(19) United States
(12) Patent Application Publication
(10) Pub. No.: US 2014/0136372 A1
(43) Pub. Date: May 15, 2014

(54) SYSTEM AND METHOD FOR GENERATING SALES LEADS FOR CEMETERIES UTILIZING THREE-HUNDRED AND SIXTY DEGREE IMAGERY IN CONNECTION WITH A CEMETERY DATABASE

(71) Applicant: James William Pinocchio, Citrus Heights, CA (US)

(72) Inventor: James William Pinocchio, Citrus Heights, CA (US)

(21) Appl. No.: 14/078,418

(22) Filed: Nov. 12, 2013

Related U.S. Application Data
(60) Provisional application No. 61/724,698, filed on Nov. 9, 2012.

(51) Int. Cl. G06Q 30/06; G06F 17/30; H04N 5/232

(52) U.S. Cl. CPC G06Q 30/0625; H04N 5/23238; G06F 17/30274
USPC 705/26.62; 348/36

(57) ABSTRACT

A device and a method for generating sales leads for cemeteries utilizing three-hundred and sixty degree panoramic imagery in connection with a cemetery database is provided where a cemetery database made up of cemetery interment data is combined with three-hundred and sixty degree imagery of the cemetery and a user interface is built to search and view the combined database. By providing access to the combined database and using data request functions in the user interface, sale leads will be generated for the cemeteries.

This application claims the benefit of U.S. Provisional Application No. 61/724698, filed Nov. 9, 2012.

### FIELD OF THE INVENTION

This invention relates to cemetery sales lead generation devices, and, more particularly, a sales lead generation device that that utilizes a cemetery databases that is in connection with three-hundred and sixty degree imagery.

### BACKGROUND OF THE INVENTION

Cemeteries have directories of names, dates, location of plots, and two dimensional maps that can be used to located a particular plot or interment. The cemetery maps usually include roadways, structures and other details and these maps often utilize a unique naming convention to the particular cemetery. Up until now, there has never been the connection of this information kept by a cemetery with a three-hundred and sixty degree image map of the cemetery. Individuals searching for particular interment have not previously been able to search over the Internet utilizing a three-hundred and sixty degree degree image of the interment sites. Additionally, there has not previously existed a sales lead generation tool used by cemeteries that incorporated the use of three-hundred and sixty degree imagery of any type. This invention creates a new manner in which individuals may search through cemetery databases and a new manner for cemeteries to generate sales leads by utilizing three-hundred and sixty degree imagery mapping with other cemetery data.

### SUMMARY OF THE INVENTION

In one embodiment of the invention a sales lead generation system may contain a searchable cemetery database, a cemetery database containing names, dates and locations of interments within the cemetery, two dimensional maps and drawings of cemeteries that includes roadways, physical structures and detailed unique naming conventions which includes layout of lots, sections, rows and plots; a three-hundred and sixty degree map of interments created by the use of a three-hundred and sixty degree mapping system that may include a Point Grey Ladybug camera system (or a functional equivalence), a portable computing system such as a laptop computer, a power supply, a global positioning system, and a customized backpack and customized hardware that mount all the components into a three-hundred and sixty degree mapping system; and an interface to search the database in the form of a website that may be found on the Internet that may allow searching by name, date, location or cemetery name, and may provide results in the form of text data, two dimensional cemetery maps and three-hundred and sixty degree panoramic images and any interconnected data between the three, and may also allows for lead generation by way of having a user input contact data into the website that may be sent to a cemetery, and by providing web page space to display cemetery services, allows for memorials and memorial pages to be created by a user by sending data through the website to the cemetery for approval to be posted on the website and provides a function to a user to tag a particular location found in the three-hundred and sixty degree viewer and link that image to the cemetery interment data.

In another embodiment the invention may be a method for creating a cemetery sales leads by using a searchable cemetery database, collecting cemetery data containing names, dates and locations of interments within the cemetery, two dimensional maps and drawings of cemeteries that includes roadways, physical structures and detailed unique naming conventions which includes layout of lots, sections, rows and plots; creating a three-hundred and sixty degree map of interments by the use of a three-hundred and sixty degree mapping system that may include a Point Grey Ladybug camera system (or a functional equivalence), a portable computing system such as a laptop computer, a power supply, a global positioning system, and a customized backpack and customized hardware that mount all the components into the three-hundred and sixty degree mapping system; interconnecting the cemetery data and three-hundred and sixty degree maps and other relevant data into a database that includes overlaying existing cemetery drawings and maps and superimposing onto a mapping source and tagging three-hundred and sixty degree images with two dimensional maps, and; providing the data in a interface on a website that may be found on the Internet that allows searching by name, date, location or cemetery name, and may provide results in the form of text data, two dimensional cemetery maps and three-hundred and sixty degree panoramic images and any interconnected data between the three, and may also allow for lead generation by way of having a user input contact data into the website that can be sent to a cemetery, by providing web page space to display cemetery services, and allow for memorials and memorial pages to be created by a user by sending data through the website to the cemetery for approval to be posted on the website, and by having a user tagging interface that collects user information when a user links image data with the cemetery data and send the user information to the cemetery.

### BRIEF DESCRIPTION OF THE DRAWINGS

In the accompanying drawings, various objects, features and advantages of the invention will be readily apparent according to the following description exemplified by the drawings, which are shown by way of example only, wherein:

FIG. 1 illustrates a chart displaying the components and functions of a cemetery sales lead generation system;

FIG. 2 illustrates the components that can be used to create a three-hundred and sixty degree mapping system;

FIG. 3 illustrates an example of a user interface to the cemetery database;

FIG. 4 illustrates an example of a memorial page of the user interface;

FIG. 5 illustrates an example of a search page that can search the cemetery database;

FIG. 6 illustrates an example of a cemetery services page of the user interface;

FIG. 7 illustrates an example of an about cemetery page of the user interface;

FIG. 8 illustrates an example of a cemetery contact page of the user interface;

FIG. 9 illustrates an example of two-dimensional maps that may be supplied by cemeteries.

### DETAILED DESCRIPTION

Reference will now be made to embodiments of the cemetery sales lead generator, examples of which are illustrated in the accompanying drawings. Details, features, and advantages of cemetery sales lead generator will become further apparent in the following detailed description of embodiments thereof.

Any reference in the specification to “one embodiment,” “a certain embodiment,” or a similar reference to an embodiment is intended to indicate that a particular feature, structure, or characteristic described in connection with the embodiment is included in at least one embodiment of the invention. The appearances of such terms in various places in the specification are not necessarily all referring to the same embodiment.

The cemetery sales leads generation system 100 will provide cemeteries with a sales lead generation tool and a searching tool for the general public to search for past family, friends or notable people to see where they are interned and see the interment site through three-hundred and sixty degree panoramic imagery.

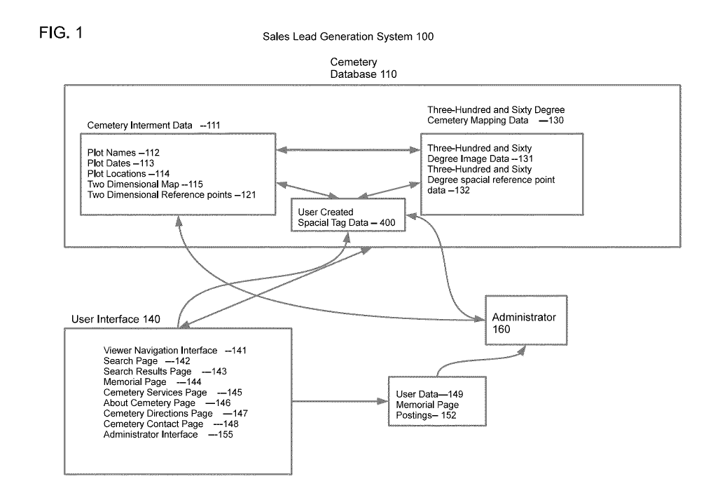

The sales lead generation system 100 may utilize a custom created cemetery database 110. FIG. 1 shows the interconnected components of one embodiment of a cemetery database 110. The cemetery database 110 may be made up of cemetery interment data 111 that may consist of plots names 112, plot dates 113, plot locations 114, two dimensional maps 115 made up of sections 116, rows 117, plots 118, cemetery roadways 119, cemetery landmarks 120, two dimensional reference points 121; and three-hundred and sixty degree cemetery mapping data 130 that may contain three-hundred and sixty degree image data 131, and three-hundred and sixty degree spacial reference point data 132. The two dimensional reference points 121 may be made up of an x-y axis data or section and row data, or other customary cemetery reference point conventions. The three-hundred and sixty degree spacial reference point data 132 may be made up of an x-y-z axis data, or GPS data or other customary coordinates used in conjunction with the three-hundred and sixty degree panoramic images.

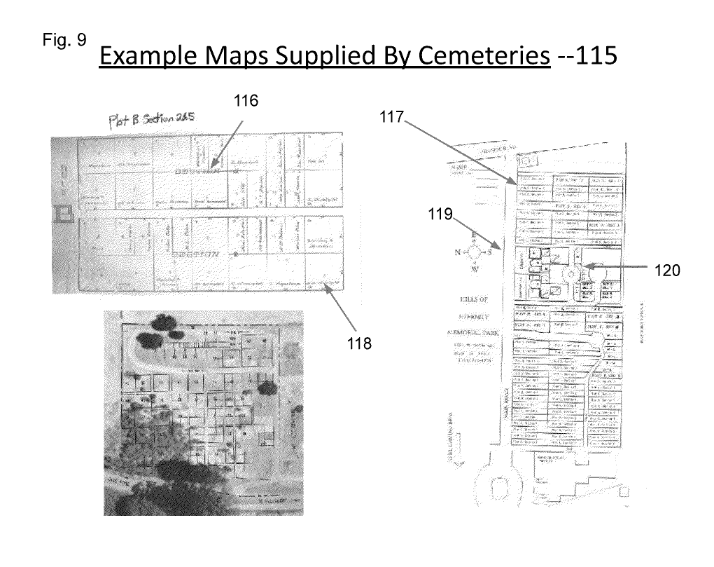

The cemetery interment data 111 may be gathered from information kept by a cemetery. Each cemetery can provide this information either electronically or in paper form. Two dimensional maps 115 that include cemetery roadways 119, cemetery landmarks 120 and detailed unique naming convention may be collected, such as in FIG. 9. These maps 115 are two dimensional graphical representations of the cemetery interments. It is understood that a cemetery may have additional information that would be relevant to the cemetery interment data 111 and such additional information may be incorporated into the cemetery interment data 111. The cemetery interment data 111 may also be gathered from other public or private records or by surveying the cemetery itself.

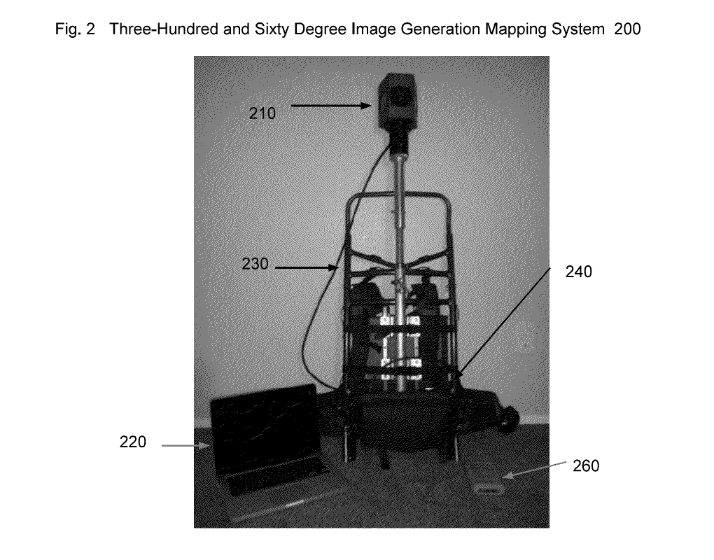

The three-hundred and sixty degree cemetery mapping data 130 may be gathered by using a custom three-hundred and sixty degree image generation mapping system 200 as seen in FIG. 2. The three-hundred and sixty degree image generation mapping system 200 can be used to map and video an entire cemetery. The three-hundred and sixty degree image generation mapping system 200 may have a multi-directional camera 210, a portable computer 220, a custom backpack mounting system 230, a power supply 240, a global positioning system 250 and a hard drive data recorder 260. The mapping system 200 can be mounted onto a custom backpack mounting system 230 that the multi-directional camera 210 is attached to. The mapping of the cemetery may take place by using the backpack mounted mapping system 200, allowing the mapping system to record and walking in a systematic fashion throughout the cemetery going through each section and row to record the he three-hundred and sixty degree images data 131. The backpack system 230 can also be equipped with a global positioning system 250 to track and geospatially locate the three-hundred and sixty degree images data 131 with three-hundred and sixty degree spacial reference point data 132. This geospatial location function may place location data in the form of a sixty degree spacial reference point data 132 within the three-hundred and sixty degree images data 131.

In one embodiment the three-hundred and sixty degree cemetery mapping data 130 may be processed and overlaid with a graphically developed cemetery two dimensional map 115, thereby linking information between the cemetery interment data 111 and the three-hundred and sixty degree cemetery mapping data 130. This overlaying process may take place by linking corresponding two dimensional reference points 121 with three-hundred and sixty degree spacial reference points 132. The two-dimensional map 115 may also be in the form of aerial view photography in addition to hand-drawn paper maps.

The multi-directional camera 210 may be a Point Grey Ladybug camera or another multi-directional camera of functional equivalence. The portable computer 220 may be any computing device that can interface with the multi-directional camera 210 and may be a laptop, smart phone or any other functional equivalent. Alternative embodiments may utilize a custom electric scooter that can be used with the backpack 230 to capture the three-hundred and sixty degree image data 131.

Software may be use to create the three-hundred and sixty degree cemetery mapping data 130. Point Grey Research offers open source software called the Ladybug SDK. This software can process the captured three-hundred and sixty degree cemetery mapping data 130 and link the corresponding three-hundred and sixty degree spacial reference point data 132 to the three-hundred and sixty degree image data 131. Custom post processing software may also be used to further correct the locations of the three-hundred and sixty degree stream files.

In another embodiment the cemetery database may contain user created spacial tag data 400. This user created spacial tag data 400 may have data that links a particular three-hundred and sixty degree cemetery mapping data 130 with the cemetery interment data 111. The spacial tag data 400 may contain information linking a particular three-hundred and sixty degree image data 131 with any of the cemetery interment data 111, plots names 112, plot dates 113, plot locations 114, two dimensional maps 115 or two dimensional reference points 121. Furthermore, the spacial tag data 400 may be linked to multiple forms of data within the cemetery interment data 111. In one embodiment the user spacial tag data 400 creates the link between the two dimensional reference points 121 and the three-hundred and sixty degree spacial reference point data 132.

The sales lead generation system 100 may also have a user interface 140. The user interface 140 may be a website portal made up of various web pages. Some of these web pages may be a custom viewer navigation interface 141, search page 142, search result page 143, memorial page 144, cemetery services page 145, about cemetery page 146, cemetery directions page 147, and cemetery contact page 148. The user interface 140 may also have functionality to deliver user data 149 to an administrator 160. The administrator may be a cemetery or agent with the responsibility of maintaining the user interface 140. The user interface 140 may have an administrator interface 155 that an administrator 160 may use to collect and deliver user data 149 approve or deny memorial page postings 152 and verify user created spacial tag data 400.

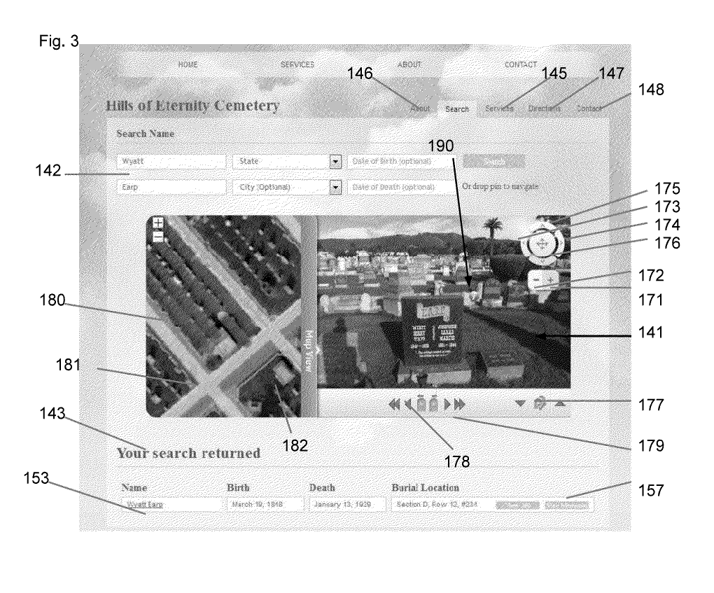

In one embodiment, as seen in FIG. 3, a custom viewer navigation interface 141 may be developed using Flash software to display three-hundred and sixty degree panoramas 131 and allow a tool for users to virtually view and tour any location throughout the particular cemetery site. Custom icons can allow the user to zoom in 171 and out 172 and move left 173, right 174, front 175 and back 176, move the viewer image to an adjacent row 177, move backward through a row 178 and forward through a row 179. Custom software may be created to develop a detailed map 180 displaying roads 181, structures 182 and other unique naming convention of the each cemetery. The map may be overlaid to combine and cross reference data found within the cemetery interment data 111 and the three-hundred and sixty degree cemetery mapping data 130. The map overlay can be embedded within the two-dimensional map 180 and combined with adjacent features on the custom viewer navigation interface 141. Added features may include allowing a user to navigate the three-hundred and sixty degree panorama by using an interface such as a computer cursor to spin the panoramic picture around. The custom viewer 170 can allow a user to navigate a three dimensional landscape virtually by means of spinning the panoramic image and navigating forwards and backwards through the image.

The user interface 140 may also allow uploading data to the cemetery database 110. Through the administrator interface 155 the administrator may upload a two dimensional image into the cemetery database 110 that is linked to a two dimensional reference points 121, so to be able to update the cemetery database 110 after the three-hundred and sixty degree mapping has taken place. Additionally, the administrator 160 may upload data entries of plot names 112, plot dates 113, and plot locations 114 and other cemetery interment data 111 as they change through time.

The user interface 140 may also contain a user created spacial tagging feature 190. The tagging feature may be contained within the custom viewer navigation interface 141. The user may make the tag by selecting the spacial tagging feature 190 in the custom viewer navigation interface 141. The resulting user created spacial tag data 400 creates a link between the cemetery interment data 111 and the three-hundred and sixty degree cemetery mapping data 130. In one embodiment, when a user conducts a subsequent search containing a linked user created spacial tag data 400, the custom viewer navigation interface 141 will display the tagged image location. The website administrator 160, who may be the cemetery itself, will verify the tagging. As a part of the user created spacial tagging feature 190, users may be asked for their contact information 149 as a part of the verification process. The contact information 149 can then be sent to cemeteries as a form of new sales leads.

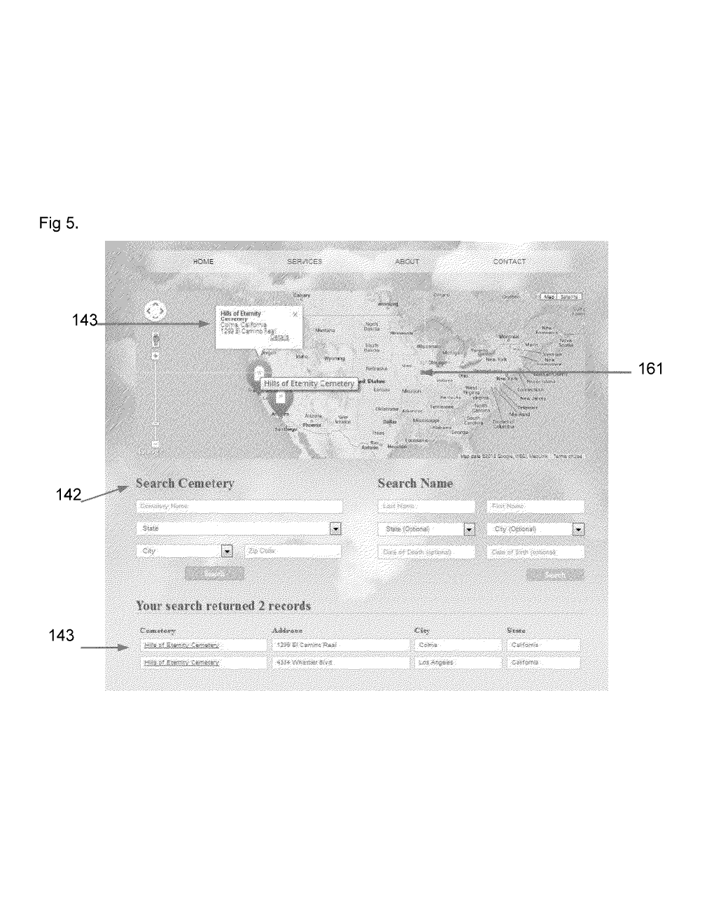

The user interface 140 may additionally contain the following functions and features. As seen in FIG. 3 and FIG. 5, a search function 142 can be developed to allow the user to search the database for names and locations of cemeteries located within the database. The user may search by either the name of the interred individual or by the name of the cemetery. Search results 143 may consist of names and location as defined by each cemeteries unique name convention. As seen in FIG. 5, search results may also show a list of cemeteries that may match the search criteria and show the cemeteries locations on a search results map 161. It would be understood that FIG. 5 represents an embodiment where the principle home page of the user interface 140 incorporates both the search page 142 with the search results page 143 and provides cemetery search engine experience for the user.

One embodiment may entail having a search functionality that allows the user to begin with a bird's-eye-view of the cemetery and allow the user to zoom into a section of interest where the individual's interment is located, as found in the search result. The user may then enter the three-hundred and sixty degree ground view of that section and begin searching for the particular site or headstone they are interested in by moving up, down and between the rows virtually. In this way the cemetery can be virtually toured. Once a grave site is found, a user can tag the site as being connected to a particular interment.

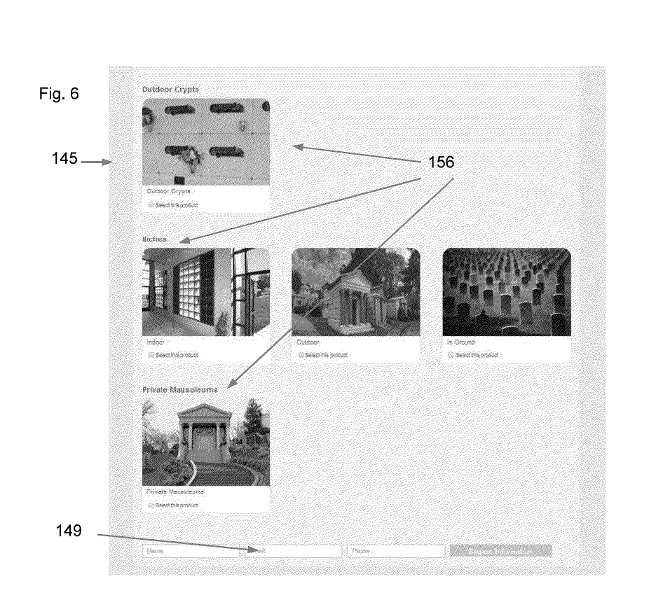

As seen in FIG. 6, a custom page may be developed to display services 145 offered at the particular cemetery searched or the cemetery linked to the search result. Existing services 156 and proposed services for sale that a particular cemetery offers to their customers may be collected to be included in cemetery services page 145. The gathered services information may include a list and description of each service. It can also include photos corresponding to each service offered. The development of cemetery services page 145 displaying services 156 offered at each cemetery may appear on the main website page (FIG. 5) whenever a search is made linked to that cemetery, along with the necessary contact information. The individual may also see areas within the cemetery that are available for future interments. The cemetery services page 145 can allow the user to make a selection of services offered and allow the input of their contact information 149. These leads may be directly sent to the particular cemetery via email or the generation of daily reports. These leads may also be accessed through the administrator interface 155.

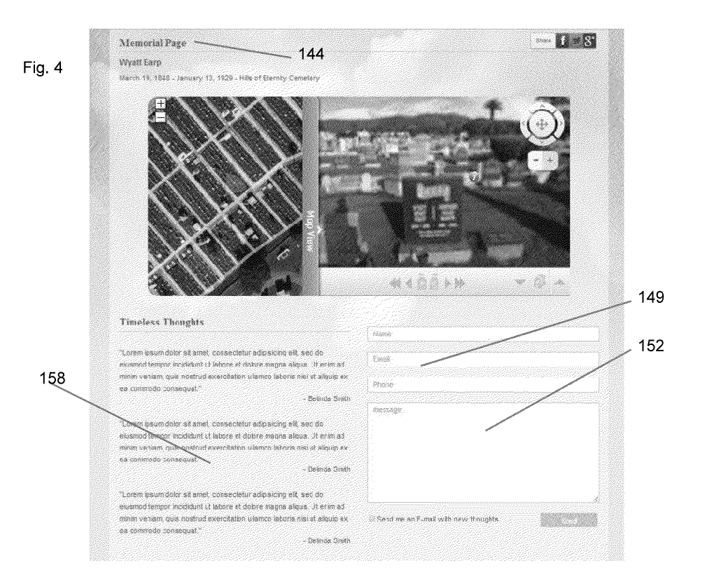

FIG. 3 shows that a link 157 may be developed to display a memorial page 144 for each search result 143. As seen in FIG. 4, a user may if he or she desires post a memorial message 158. The posting interface 152 can allow for the input of the contact information of the user 149. The proposed memorial message 158 can be sent to the particular cemetery for approval via the administrator interface 155. Memorial messages may be of the type to allow users to pay respects to the interred individual, while the cemetery administrator 160 has the ability as a message moderator. The contact information 149 collected can be sent directly to the cemetery by email or the generation of daily reports. The memorial page contact info 149 also may be accessed through the administrator interface 155. The memorial page may also utilize a custom viewer 141 and display the cemetery map 180 that show the location of the particular interment. In one embodiment a link 153 to a location given from the search result 143 can be used to navigate the user to the memorial page 144 for the search result individual.

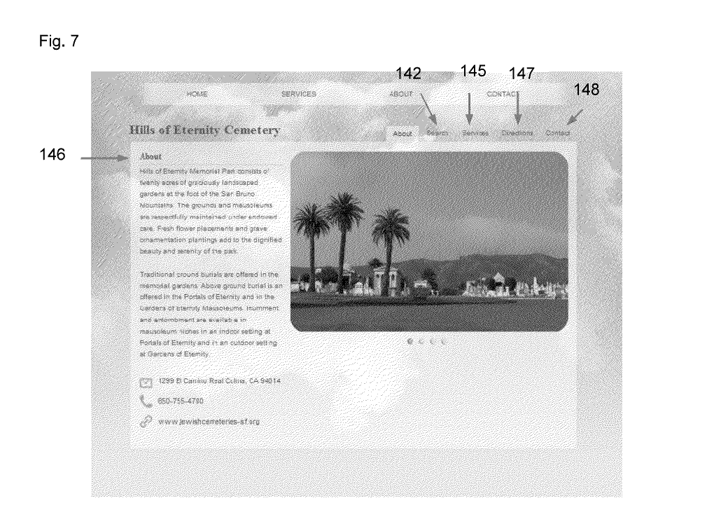

FIG. 7 shows the an about cemetery page 146. The about cemetery page may provide information about the particular cemetery, its religious affiliation, if any, its location and other contact information. The about cemetery page can be a landing page when the user searches for a cemetery rather than an individual and clicks the link to view that cemetery. One possible embodiment is to provide cemeteries with a stand-alone un-branded website. This customized website user interface 141 may feature the same mapping, search and location features mentioned above, but with a customized look and style.

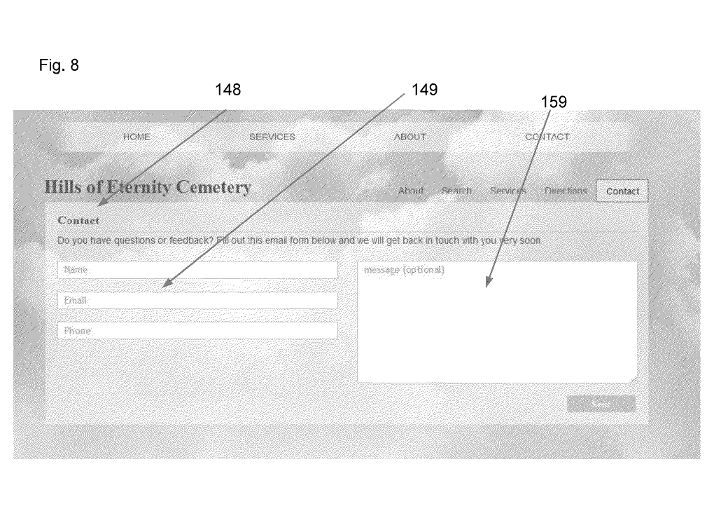

FIG. 8 depicts the cemetery contact page 148. The cemetery contact page 148 may collect user data 149 and a user message 159. The user data 149 and user message 159 will be sent to the administrator 160 and may be viewed using the administrator interface 155. The user contact data 149 collected by the cemetery contact page 148 may be used as a source for cemetery sales leads. The sale leads information may be gathered and accessible to the administrator 160 from the administrator interface 155. The sale lead information may also be sent directly to a predetermined email or other contact address. These directly sent sales leads may be programmed to be sent daily, weekly or on any other time basis and may be sent in a stand alone fashion or alone with usage reports that may be generated by the user interface 141.

While specific embodiments of the invention have been described in detail, it should be appreciated by those skilled in the art that various modifications and alternations could be developed in light of the overall teachings of the disclosure. Accordingly, the particular arrangements, apparatuses, systems, and methods disclosed are meant to be illustrative only and not limiting as to the scope of the invention.

I claim the following:

1. A cemetery sales lead generation device comprising:
A cemetery database,
said cemetery database containing cemetery interment data and three-hundred and sixty degree cemetery image data, said cemetery interment data containing interment plot data and two dimensional reference point data, said three-hundred and sixty degree cemetery image data having three-hundred and sixty degree spacial reference point data, said two dimensional reference point data being connected to corresponding three-hundred and sixty degree spacial reference point data; and
a database interface,
said database interface being interconnected to said cemetery database, said database interface having a user data request interface, said database interface having a three-hundred and sixty degree image data viewer interface.

2. The cemetery sales lead generation device of claim 1 wherein
said cemetery database has a user created spacial tag data, said user created spacial tag data is linked to said cemetery interment data, said user created spacial tag data is linked to said three-hundred and sixty degree cemetery image data; and
said database interface has a spacial tag creation interface, said spacial tag creation interface is interconnected to said user created spacial tag data.

3. The cemetery sales lead generation device of claim 2 wherein said user created spacial tag data is linked to said two dimensional reference point data, and said user created spacial tag data is linked to said three-hundred and sixty degree spacial reference point data.

4. The cemetery sales lead generation device of claim 3 wherein, said user created spacial tag data contains said two dimensional reference point data corresponding with said three-hundred and sixty degree spacial reference point data, said user created spacial tag data contains corresponding said cemetery interment data, and said cemetery interment data contains interment plot identification data.

5. The cemetery sales lead generation device of claim 1 wherein said user database has a search function interface.

6. The cemetery sales lead generation device of claim 1 wherein said user database has a memorial page interface.

7. The cemetery sales lead generation device of claim 1 wherein said user database has a cemetery services interface.

8. The cemetery sales lead generation device of claim 1 wherein said user data request interface collects user contact information.

9. The cemetery sales lead generation device of claim 8 wherein said user contact information is connected to a database administrator interface.

10. The cemetery sales lead generation device of claim 6 wherein said memorial page interface is connected to a database administrator interface.

11. The cemetery sales lead generation device of claim 6 wherein said memorial page interface collects user contact information.

12. A method for creating cemetery sales leads comprising:
building a cemetery database by gathering cemetery interment data and three-hundred and sixty degree cemetery image data,
linking said cemetery interment data with said three-hundred and sixty degree cemetery image data,
creating a cemetery database interface that allows for searching of cemetery database data and viewing said three-hundred and sixty degree cemetery image data,
collecting user contact information from a user data request interface connected to said cemetery database interface, and
providing user contact information to a cemetery.

13. A method for creating cemetery sales leads of claim 12 further comprising, gathering said three-hundred and sixty degree cemetery image data by mapping a cemetery using a three-hundred and sixty degree camera to take panoramic image data.

14. A method for creating cemetery sales leads of claim 12 further comprising,
linking said cemetery interment data with said three-hundred and sixty degree cemetery image data by cross referencing two-dimensional spacial reference point data with three-hundred and sixty degree spacial reference point data, said two-dimensional spacial reference point data being linked to said cemetery interment data, and said three-hundred and sixty degree spacial reference point data being linked to said three-hundred and sixty degree cemetery image data.

15. A method for creating cemetery sales leads of claim 12 further comprising,
collecting user created tag data from a spacial tag creation interface.

16. A method for creating cemetery sales leads of claim 15 further comprising,
connecting said user created tag data to said cemetery interment data,
connecting said user created tag data to said three-hundred and sixty degree cemetery image data, and
using said user created tag data to cross reference said cemetery interment data with said three-hundred and sixty degree cemetery image data.

17. A method for creating cemetery sales leads of claim 12 further comprising, collecting user generated post data from a user generated post data interface.

18. A method for creating cemetery sales leads of claim 12 further comprising, administrating an approval process on said user generated post data.

19. A method for creating cemetery sales leads of claim 12 further comprising, providing cemetery service information on said cemetery database interface.

20. A cemetery sales lead generation device comprising:
a first database,
said first database being a cemetery interment database having interment plot data, interment location data, interment name data, interment date of birth data, interment date of death data, two dimensional cemetery reference point data, two dimensional cemetery map data, cemetery landmark data, cemetery section data;
a second database,
said second database being a three-hundred and sixty degree cemetery image database having, three-hundred and sixty degree panoramic cemetery image data, three-hundred and sixty degree spacial reference point data;
a third database,
said third database being spacial tag database having user created spacial tag data, and user reference data;
a user interface,
said user interface having a search function interface, a spacial tag creation interface, a user data request interface, a three-hundred and sixty degree image data viewer interface, a two-dimensional map viewer interface, a zoom function interface, a memorial page interface, a cemetery services interface, an administrative function interface, a two-dimensional image upload interface;
where said first database is linked to said second database; said third database is linked to said first database and said second database; said user interface is linked to said first database, said second database and said third database; said user created spacial tag data is linked to said two dimensional cemetery reference point data and said three-hundred and sixty degree spacial reference point data; said spatial tag data is linked to said interment plot data, interment location data, and interment name data; said search function interface is linked to said first database and said second database; said spacial tag creation interface is linked to said third database; said user data request interface is linked to said third database; said three-hundred and sixty degree image data viewer interface, is linked to said second database; said two-dimensional map viewer interface is linked to said first database, said zoom function interface is linked to said second database; said memorial page interface is linked to said first database, said second database, and said third database; said cemetery services interface is linked to said first database and said third database; said administrative function interface is linked to said first database, said third database, said spacial tag creation interface, said user data request interface, said memorial page interface, and said cemetery services interface; and said two dimensional image upload interface is linked to said first database and said administrative function interface.
